(19) United States
(12) Patent Application Publication
(10) Pub. No.: US 2008/0189839 A1
(43) Pub. Date: Aug. 14, 2008

(54) Piece of Garment

(75) Inventor: Bob W. Lambertz, Pfaffikon (CH)

Correspondence Address: Olson & Cepuritis, LTD., 20 NORTH WACKER DRIVE, 36TH FLOOR, CHICAGO, IL, 60606, US

(73) Assignee: X-TECHNOLOGY SWISS GMBH, Freienbach (CH)

(21) Appl. No.: 11/663,516

(22) PCT Filed: Sep. 9, 2005
(86) PCT No.: PCT/DE05/01579

§ 371 Date: Mar. 21, 2007

(30) Foreign Application Priority Data
Sep. 23, 2004 (DE) 20 2004 014 975.3

(51) Int. Cl. A62B 17/00; A41D 27/00; A41D 1/00

(52) U.S. Cl. 2/458; 2/81; 2/243.1; 2/69

(57) ABSTRACT

The invention relates to a piece of garment, particularly for use in sports activities such as jogging, skating, skiing, or similar. Air-conditioning areas (11, 12, 13, and 14) are provided in the region most affected by perspiration.

The invention relates to an item of clothing, in particular for use in athletic activities such as jogging, skating, skiing or the like.

Clothing serves to protect a person, in particular for protecting against weather. Under certain conditions, e.g., with athletic activity, clothing also helps to protect against injuries. Furthermore, at high outdoor temperatures, clothing consists primarily of several different clothing items that are worn one above the other in multiple layers. The outermost layer of clothing essentially has the function of being wind repellant and water repellant to prevent cooling of the person due to wind and to protect him from the penetration of water into the clothing when there is precipitation.

With multiple layers of clothing in particular, there may be production of perspiration. In human athletic activity, this production of perspiration is above average. The wearing comfort of clothing is significantly reduced by perspiration. Especially in the areas where the greatest production of perspiration occurs, e.g., in the area of the underarms, an unpleasant feeling develops on the skin, which increases the risk of chills, strains or the like in the subsequent cooling after athletic activity. To reduce these risks, there have been attempts to facilitate the wicking of perspiration.

It is known here that clothing items may be provided with terry loops on the side facing the skin to allow the moisture to be absorbed. One disadvantage of clothing items designed in this way is that although the terry cloth absorbs moisture, it does not wick it away from the skin, but instead absorbs it into the fabric. Therefore, the moisture remains in the clothing item so that after athletic activity the areas of clothing covering sections of high perspiration are wet. They then remain in contact with the skin which leads to an unpleasant feeling on the skin. The unpleasant feeling is reinforced in particular by the fact that following athletic activity, both the person and the clothing cool off and thus cold moisture in the clothing item comes in contact with the skin.

In addition, it is known that aeration may be provided in the area of greatest perspiration in order to prevent excessive perspiration. These measures are successful only to a very limited extent. Furthermore, the ventilation, which is usually designed in the form of holes in the clothing, lead to an unpleasant wearing feeling in wind or a draft, in particular when perspiration has already been formed.

Therefore, the object of this invention is to create a clothing item that will allow evaporation of moisture as it is produced while at the same time preventing cooling or penetration of moisture and drafts from the outside at the areas that are under particularly great stress. According to this invention, this object is achieved by providing climate zones in the area of the heaviest perspiration.

This invention creates a clothing item, in particular for athletic activities, that significantly improves the wicking of sweat as it is produced and forms protection against cooling. By providing different climate zones in clothing, there is the possibility of providing perspiration-absorbing and perspiration-wicking areas in clothing, depending on the amounts of perspiration produced in certain body areas.

Other embodiments and refinements of the invention are characterized in the other subordinate claims. An exemplary embodiment of the invention is depicted in the drawing and described in detail below:

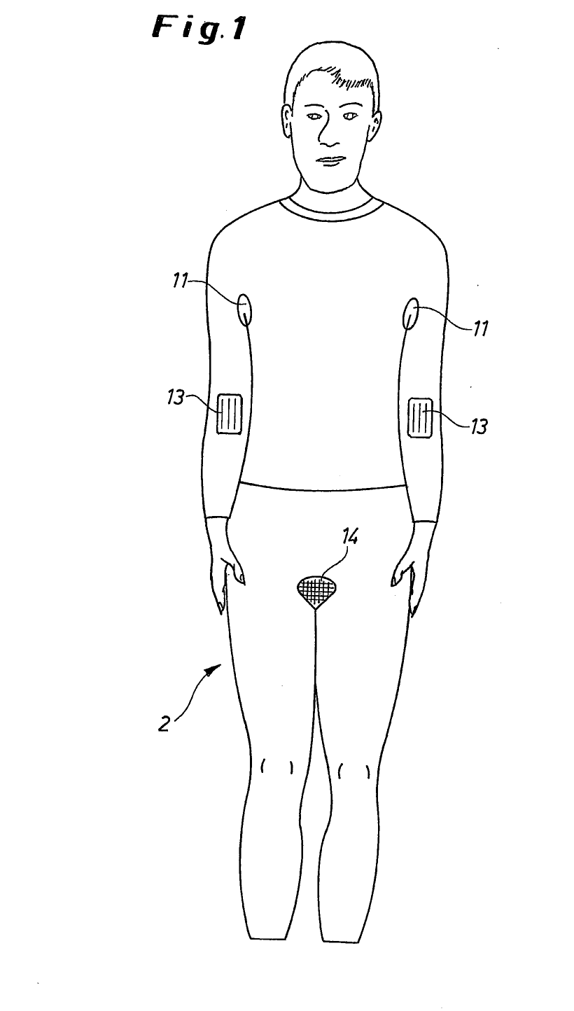

FIG. 1 shows a view of a person wearing clothing as seen from the front;

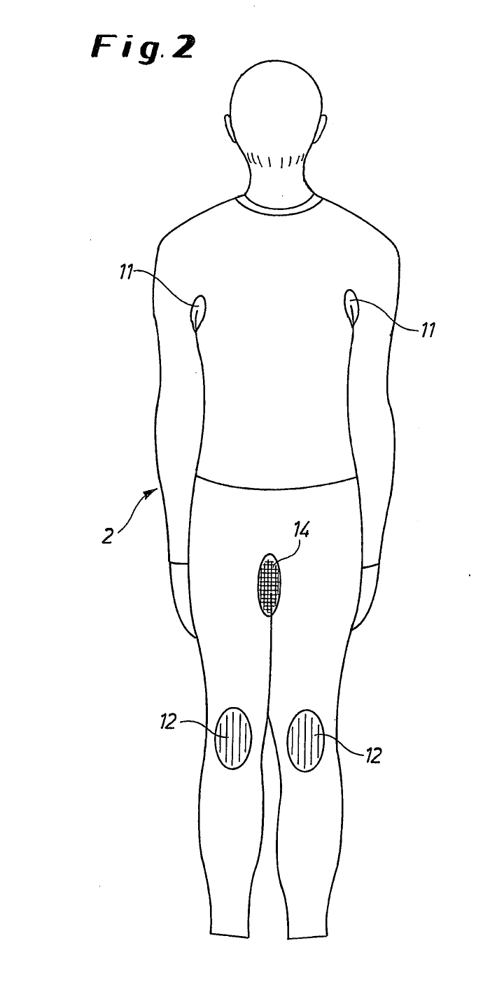

FIG. 2 shows a view of the person shown in FIG. 1, as seen from the rear;

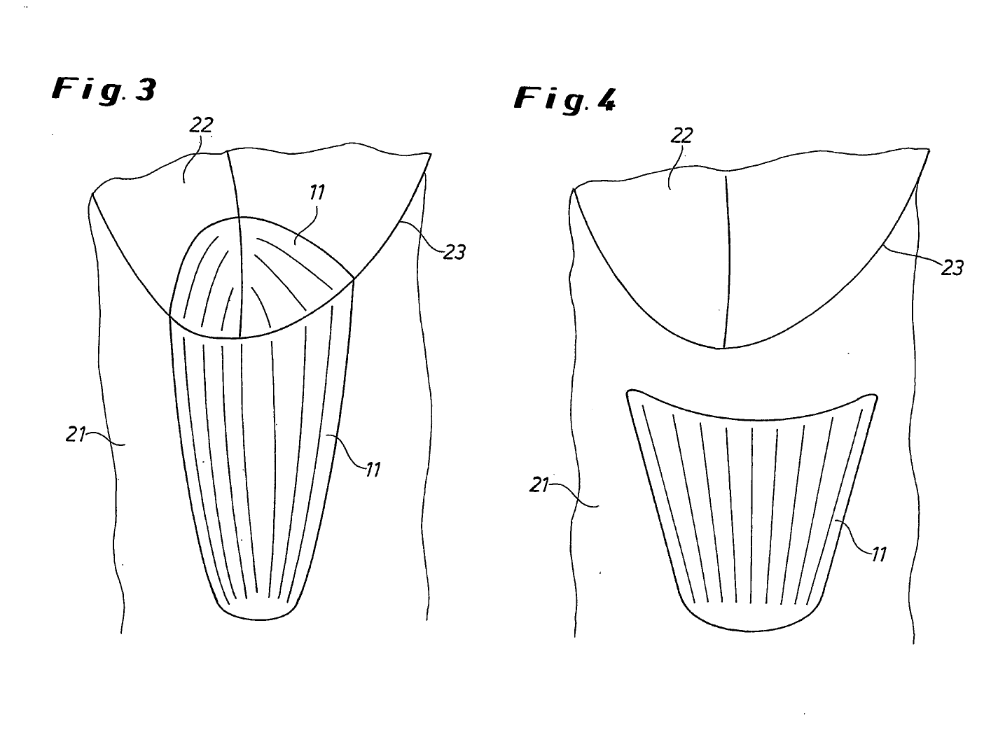

FIG. 3 shows a detail of an underarm climate zone with the person's arm pointing upward and

FIG. 4 shows a detail of an underarm climate zone with the arm pointing upward in a different embodiment.

The clothing item 2 selected as an exemplary embodiment is an overall. The overall covers the person as shown here from the neck to the wrists and to the ankles. The clothing item 2 has different climate zones 11, 12, 13 and 14. Climate zones 11, 12, 13 and 14 are made of different materials. Use of blends of materials such as sheared wool with elastomer fiber materials, e.g., elasthane, or hollow chamber fibers is possible.

The climate zone 11 is situated in the area of the underarm. The climate zone 11 contributes toward wicking of moisture away from this area, which is exposed to particularly heavy perspiration. The climate zone 11 is formed by a plurality of ribs arranged in parallel. They are produced by a ribbed knitting style. With this style of knitting, the fabric does not lie completely next to the skin so that more air can reach the skin. In the exemplary embodiment, these areas are made of Nexten. The ribbing ensures on the one hand a high measure of freedom of movement while on the other hand forming small channels between the ribs that contribute toward improved wicking of perspiration.

In the exemplary embodiment according to FIG. 3, the climate zone 11 is arranged directly in the area of the underarm and extends both on the area 21 of the upper body of the clothing item 2 as well as to the arm 21 of the clothing item 2. This creates a climate zone with a very large area. In the exemplary embodiment according to FIG. 4, however, the climate zone 11 is provided only in the area 21 of the upper body of the clothing item 2 and is at a distance from the seam 23 in the sleeve 22. Therefore the climate zone is arranged somewhat below the underarm and therefore reliably absorbs perspiration as it runs down.

The climate zone 12 is arranged in the area of the back of the knees. The climate zone 12 is made of very thin fabric that absorbs perspiration produced here and allows it to evaporate.

The climate zone 13 is arranged in the area of the inside of the elbow. The climate zone 13 is made of very thin material, which leads to very good climate regulation in the inside of the elbow which is under particular load due to high body temperatures in athletic activity.

In the crotch area an additional climate zone 14 is provided. This climate zone 14 is made of a special mesh knit fabric in which only 80% of the skin is covered by the yarn used. This creates optimal air circulation. Furthermore the yarn used is especially gentle to skin and has a low coefficient of friction to reduce the risk of chaffing due to friction.

In a modification of the exemplary embodiment, the climate zones 11, 12, 13 and 14 are provided with expansion joints to allow optimal freedom of movement.

In addition to the climate zones 11, 12, 13 and 14, the clothing item 2 may be provided with padding whereby in particular so-called strip padding may be used. This padding is preferably provided in the area of the calves and the forearms. This padding is preferably made of hollow chamber fibers which are spun with cotton or wool. The hollow chamber synthetic yarns are especially good for absorbing impact and pressure. Furthermore, padding may also be provided in the area of the Achilles tendon to prevent abrasion with high top shoes. In addition, there is the possibility of providing light padding in the area of the thigh to also reduce the risk of cooling and/or penetration of moisture in this area.

The inventive clothing item takes into account the different stresses that occur especially in athletic activity by providing climate zones. For example in zones where high body temperatures and heavy perspiration occur in athletic activities such as the hollows of the knee, the inner elbows, underarms and crotch, climate zones are provided to prevent a buildup of heat and to wick perspiration away from the skin and improve evaporation.

Although the description and the claims mention a clothing item, the present invention is not limited merely to such a one-piece design but instead individual climate zones or all climate zones may also be distributed among multiple items of clothing, e.g., in the form of a top part and pants. The combination of individual features or all features of the invention in separate clothing items is also covered within the scope of the present invention. The features of this invention may be provided in both underclothes as well as outerwear.

1. A clothing item, in particular, for use in athletic activity, such as, jogging, skiing or the like, characterized in that climate zones (11, 12, 13, and 14) are provided in the areas of heaviest perspiration.

2. A clothing item according to claim 1, characterized in that the climate zones (11, 12, 13, and 14) are designed in a ribbed knitting style.

3. A (Climate) climate-regulating clothing item according to claim 1, characterized in that the climate zones (11, 12, 13, and 14) are designed in a mesh knit fabric.

4. A (Climate) climate-regulating clothing item according to claim 2 (or 3), characterized in that the climate zones (11, 12, 13, and 14) are provided with expansion joints.

5. A climate-regulating clothing item according to claim 3, characterized in that the climate zones (11, 12, 13, and 14) are provided with expansion joints.
